(19) United States
(12) Patent Application Publication
(10) Pub. No.: US 2024/0405302 A1
(43) Pub. Date: Dec. 5, 2024

(54) POWER STORAGE DEVICE AND VEHICLE

(71) Applicant: TOYOTA JIDOSHA KABUSHIKI KAISHA, TOYOTA-SHI (JP)

(72) Inventors: Keisuke UKITA, Toyoake-shi (JP); Yusuke KURUMA, Toyota-shi (JP); Tsubasa MIGITA, Sakai-shi (JP); Kei MORIKAWA, Toyota-shi (JP); Yasumasa OGUMA, Nagoya-shi (JP)

(73) Assignee: TOYOTA JIDOSHA KABUSHIKI KAISHA, TOYOTA-SHI (JP)

(21) Appl. No.: 18/640,388

(22) Filed: Apr. 19, 2024

(30) Foreign Application Priority Data
May 29, 2023 (JP) 2023-087914

(51) Int. Cl. H01M 10/48; B60L 3/00; H01M 10/52; H01M 50/249

(52) U.S. Cl. CPC H01M 10/48; B60L 3/0046; H01M 10/52; H01M 50/249; H01M 2300/0068

(57) ABSTRACT

A power storage device is a power storage device including: a battery cell having a sulfide solid electrolyte; a case that accommodates the battery cell; and at least one gas collection unit that is disposed in the case and that detects hydrogen sulfide, wherein a protruding portion is formed in a bottom surface of an inner surface of the case, and the gas collection unit is disposed in the protruding portion.

### CROSS REFERENCE TO RELATED APPLICATIONS

This nonprovisional application is based on Japanese Patent Application No. 2023-087914 filed on May 29, 2023 with the Japan Patent Office, the entire contents of which are hereby incorporated by reference.

### BACKGROUND

### Field

The present disclosure relates to a power storage device and a vehicle.

### Description of the Background Art

Conventionally, various types of power storage devices, in each of which an all-solid-state battery is mounted, have been proposed, and a power storage device described in Japanese Patent Laying-Open No. 2022-12308 includes a sulfide sensor.

### SUMMARY

It is not specifically stated how the sulfide sensor is disposed in the power storage device described in Japanese Patent Laying-Open No. 2022-12308.

As a result, even when sulfide gas is generated in the all-solid-state battery, the generation of the sulfide gas may be unable to be detected excellently depending on a mounting position of the sulfide sensor.

The present disclosure has been made in view of the above-described problem, and has an object to provide a power storage device, in which a battery cell having a sulfide solid electrolyte is mounted, and a vehicle so as to collect sulfide gas excellently in the power storage device.

A power storage device according to the present disclosure is a power storage device including: a battery cell having a sulfide solid electrolyte; a case that accommodates the battery cell; and at least one gas collection unit that is disposed in the case and that detects hydrogen sulfide, wherein a protruding portion is formed in an inner surface of the case, the protruding portion protruding from the inner surface of the case toward outside of the case, and the gas collection unit is disposed in the protruding portion. The gas collection unit is a gas detection sensor.

A plurality of the gas collection units are provided, and when a direction in which the protruding portion protrudes from the inner surface of the case toward the outside of the case is defined as a protruding direction, the plurality of the gas collection units are disposed in the protruding portion at different positions in the protruding direction.

The inner surface of the case includes a mounting surface on which the battery cell is disposed, and the protruding portion is formed to protrude toward the outside of the case with respect to the mounting surface.

The case includes a bottom plate, and the protruding portion is a groove portion formed by deforming the bottom plate so as to protrude toward the outside of the case. In a vehicle including the above-described power storage device, the power storage device is mounted on the vehicle such that the protruding portion protrudes downward. The case includes a bottom plate, the protruding portion is a groove portion formed by deforming the bottom plate so as to protrude downward, and the groove portion is formed to extend in a forward/backward direction of the vehicle.

The case includes a bottom plate, the protruding portion is a groove portion formed by deforming the bottom plate so as to protrude downward, and the groove portion is formed to extend in a width direction of the vehicle.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram schematically showing a vehicle 2 including a power storage device 1 according to the present embodiment.

FIG. 2 is a perspective view showing power storage device 1.

FIG. 3 is a perspective view schematically showing a case 20 with an upper case 31 being removed.

FIG. 4 is a cross sectional view showing power storage device 1.

FIG. 5 is a plan view schematically showing a battery cell 25.

FIG. 6 is a cross sectional view showing battery cell 25.

FIG. 7 is a flowchart showing exemplary abnormality processing control performed by a controller 11.

FIG. 8 is a perspective view schematically showing a power storage device 1A with an upper case 31 being removed.

FIG. 9 is a cross sectional view showing configurations of and around a groove portion 80.

FIG. 10 is a perspective view schematically showing a power storage device 1B with an upper case 31 being removed.

FIG. 11 is a cross sectional view showing configurations of and around a groove portion 82 and a groove portion 83.

### DESCRIPTION OF THE PREFERRED EMBODIMENTS

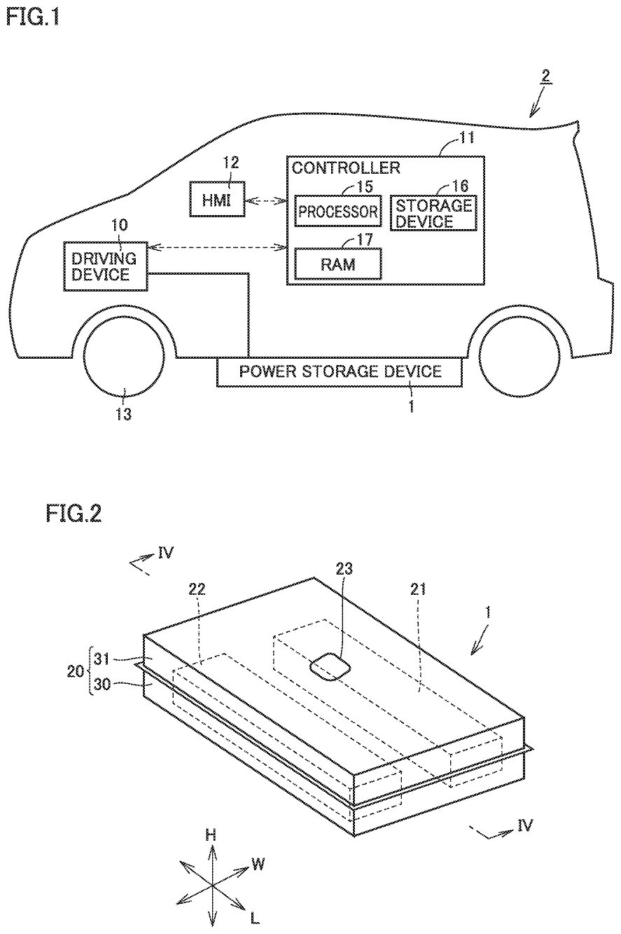

A power storage device 1 according to the present embodiment will be described with reference to FIGS. 1 to 11. Among configurations shown in FIGS. 1 to 11, the same or substantially the same configurations are denoted by the same reference characters and the same explanation will not be described.

FIG. 1 is a schematic diagram schematically showing a vehicle 2 including a power storage device 1 according to the present embodiment. Vehicle 2 is a battery electric vehicle (BEV) including no engine (internal combustion engine), but may be a hybrid electric vehicle (HEV) or plug-in hybrid electric vehicle (PHEV) including an engine.

Vehicle 2 includes power storage device 1, a driving device 10, a controller 11, an HMI (Human Machine Interface) device 12, and driving wheels 13.

Driving device 10 is connected to power storage device 1. Driving device 10 includes, for example, a PCU and a rotating electrical machine. Driving device 10 generates driving force using electric power supplied from power storage device 1, so as to drive driving wheels 13. Controller 11 controls driving of driving device 10, HMI device 12, and the like. Controller 11 includes a processor 15, a storage device 16, and a RAM 17.

HMI device 12 includes: an input unit to which various types of information are input by a user; and a display unit that displays various types of information. HMI device 12 is, for example, a touch panel display. Power storage device 1 is disposed, for example, on a lower surface of a floor panel of vehicle 2. It should be noted that power storage device 1 may be disposed in vehicle 2.

FIG. 2 is a perspective view showing power storage device 1. It should be noted that in FIG. 2 and the like, “W” represents a width direction of vehicle 2. “L” represents a forward/backward direction of vehicle 2. “H” represents an upward/downward direction.

Power storage device 1 includes a case 20, battery modules 21, 22, and a desulfurization unit 23. Case 20 includes a lower case 30 and an upper case 31. Lower case 30 is provided with an opening that opens upward, and upper case 31 is disposed to close the opening of lower case 30.

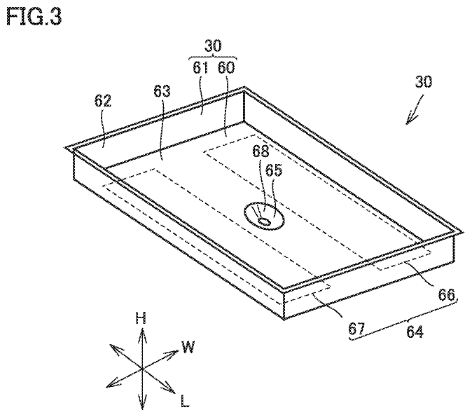

FIG. 3 is a perspective view schematically showing case 20 with upper case 31 being removed. Lower case 30 includes a bottom plate 60 and a peripheral wall 61. Peripheral wall 61 is formed to extend upward from an outer peripheral edge portion of bottom plate 60, and peripheral wall 61 is formed in the form of a loop.

An inner surface 62 of lower case 30 includes a bottom surface 63. A general surface 64 and a protruding surface 65 are formed in bottom surface 63. General surface 64 includes a mounting surface 66 and a mounting surface 67. Battery module 21 is disposed on mounting surface 66, and battery module 22 is disposed on mounting surface 67.

A recess 68 extending downward is formed in bottom plate 60. It should be noted that recess 68 corresponds to the “protruding portion” of the present disclosure. Protruding surface 65 is an inner surface of recess 68.

Recess 68 is formed to protrude from inner surface 62 toward the outside of case 20. Accordingly, protruding surface 65 is also formed to protrude from inner surface 62 toward the outside of case 20.

It should be noted that in a state in which power storage device 1 is mounted on vehicle 2, recess 68 is formed to protrude downward and protruding surface 65 is also formed to protrude downward.

Recess 68 extends downward from general surface 64, and protruding surface 65 is located below general surface 64. For example, protruding surface 65 is located below mounting surfaces 66, 67.

Recess 68 is located between mounting surface 66 and mounting surface 67. It should be noted that the position of recess 68 is not limited to this position.

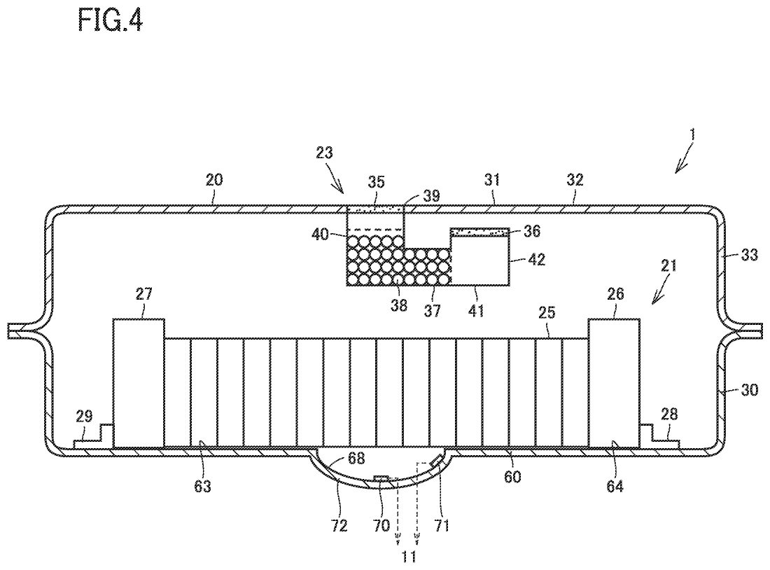

FIG. 4 is a cross sectional view showing power storage device 1 along a line IV-IV shown in FIG. 2. Recess 68 is formed by bending bottom plate 60. Power storage device 1 includes gas detection sensors 70, 71 each disposed in recess 68. Each of gas detection sensors 70, 71 collects hydrogen sulfide gas when detecting the hydrogen sulfide gas, and each of gas detection sensors 70, 71 is an example of the “gas collection unit” of the present disclosure. It should be noted that the gas collection unit may be a sulfide gas absorbing agent or the like.

Each of gas detection sensors 70, 71 is, for example, a hydrogen sulfide sensor. Each of gas detection sensors 70, 71 is a sensor that detects a concentration of hydrogen sulfide (H₂S) in the atmosphere, and the hydrogen sulfide sensor may be, for example, a hot-wire type semiconductor sensor or a potentiostatic electrolysis sensor.

Gas detection sensor 70 and gas detection sensor 71 are located at different positions in the protruding direction in which recess 68 protrudes toward the outside of case 20. In the state in which power storage device 1 is mounted on vehicle 2, the positions of gas detection sensor 70 and gas detection sensor 71 are different in the upward/downward direction. Specifically, gas detection sensor 71 is located above gas detection sensor 70. Each of gas detection sensors 70, 71 transmits a signal indicating a detection result to controller 11.

It should be noted that in the example shown in FIG. 4, recess 68 is formed by deforming a portion of bottom plate 60 so as to protrude downward. In this way, protruding portion 72 is formed in the lower surface of bottom plate 60 so as to protrude downward. It should be noted that as a method of forming recess 68, for example, recess 68 may be formed by reducing the thickness of bottom plate 60. It should be noted that when recess 68 is formed by reducing the thickness of bottom plate 60, the bottom surface of bottom plate 60 can be made flat. Thus, when power storage device 1 is disposed in vehicle 2, ease of mounting of power storage device 1 can be improved.

Upper case 31 includes a top plate 32 and a peripheral wall 33. Peripheral wall 33 is formed to extend downward from the outer peripheral edge portion of top plate 32. It should be noted that peripheral wall 33 is fixed to lower case 30. Desulfurization unit 23 is disposed in case 20. Desulfurization unit 23 is connected to top plate 32.

Desulfurization unit 23 includes breather membranes 35, 36, a duct 37, and a desulfurization agent 38. An opening 39 is formed in top plate 32, and breather membrane 35 is provided to close opening 39.

Duct 37 includes a pipe portion 40, a pipe portion 41, and a pipe portion 42. Pipe portion 40 extends downward from opening 39. Pipe portion 41 is disposed at a lower end portion of pipe portion 40, and pipe portion 41 is formed to extend in the horizontal direction. Pipe portion 42 is connected to an end portion of pipe portion 41, and pipe portion 42 is formed to extend upward. Breather membrane 36 is provided to close an opening formed in an end portion of pipe portion 42.

Each of breather membranes 35, 36 is, for example, a breathable waterproof sheet, such as GORE-TEX (registered trademark).

Desulfurization agent 38 may be, for example, a pellet-shaped desulfurization agent including iron oxide as a main component, and chemically adsorbs hydrogen sulfide. Desulfurization agent 38 is provided in duct 37.

Battery module 21 includes: a plurality of battery cells 25 arranged in one direction; end plates 26, 27; and fixing members 28, 29.

End plate 26 is provided at one end of battery module 21, and end plate 27 is provided at the other end of battery module 21. A restraint band (not shown) is connected between end plate 26 and end plate 27. With restraint force from the restraint band, the plurality of battery cells 25 are fixed between end plate 26 and end plate 27. Fixing member 28 fixes end plate 26 to case 20, and fixing member 29 fixes end plate 27 to case 20. It should be noted that battery module 22 is configured in the same manner as battery module 21.

FIG. 5 is a plan view schematically showing battery cell 25. Battery cell 25 includes a laminate film 45, an electrode assembly 46, a positive electrode tab 47, and a negative electrode tab 48.

Electrode assembly 46 is sealed in laminate film 45. Positive electrode tab 47 and negative electrode tab 48 are connected to electrode assembly 46, and are drawn from the inside of laminate film 45 to the outside.

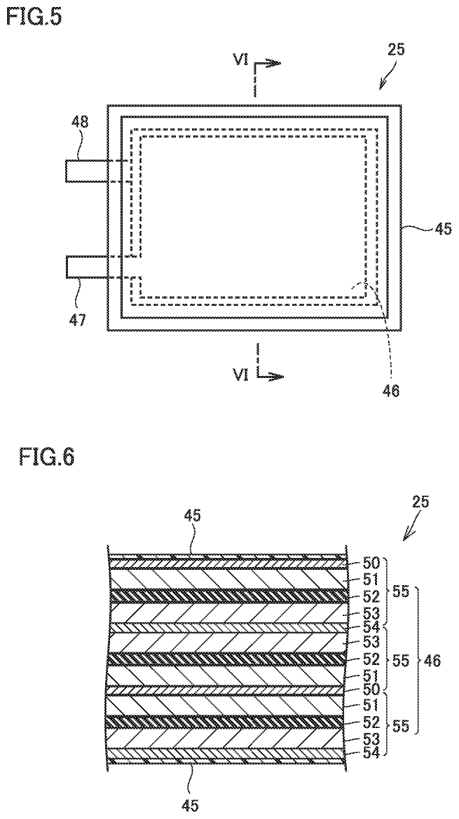

FIG. 6 is a cross sectional view showing battery cell 25. Electrode assembly 46 includes a plurality of unit batteries 55. Each unit battery 55 includes a negative electrode current collector layer 50, a negative electrode active material layer 51, a solid electrolyte layer 52, a positive electrode active material layer 53, and a positive electrode current collector layer 54.

In the present disclosure, solid electrolyte layer 52 contains a sulfur component. In the present embodiment, solid electrolyte layer 52 includes a sulfide-based solid electrolyte, and the sulfide-based solid electrolyte may be formed from phosphorus pentasulfide (P₂S₅) or lithium sulfide (Li₂S) as a starting material, for example.

Positive electrode active material layer 53 may include a sulfide-based solid electrolyte. For example, positive electrode active material layer 53 may include the sulfide-based solid electrolyte, and lithium cobaltate, lithium nickelate, lithium iron phosphate, or the like.

When solid electrolyte layer 52 is composed of an oxide-based solid electrolyte, a sulfur-based positive electrode active material is used for positive electrode active material layer 53. The sulfur-based positive electrode active material may be an organic sulfur compound or an inorganic sulfur compound. It should be noted that both solid electrolyte layer 52 and positive electrode active material layer 53 may each include a sulfur component.

Negative electrode active material layer 51 may include a sulfide-based solid electrolyte. Negative electrode active material layer 51 includes the sulfide-based solid electrolyte, a metal active material, and a carbon active material.

Examples of the metal active material include In, Al, Si and Sn. On the other hand, examples of the carbon active material include mesocarbon microbead (MCMB), highly oriented pyrolytic graphite (HOPG), hard carbon, and soft carbon.

Power storage device 1 configured as described above is charged and discharged repeatedly. In this process, hydrogen sulfide gas may be generated in battery cell 25.

For example, in FIG. 5, a clearance may be formed at a portion at which positive electrode tab 47 and negative electrode tab 48 are drawn from laminate film 45, and air may enter laminate film 45 via the clearance. Then, solid electrolyte layer 52 and water in the air may react with each other to generate hydrogen sulfide gas. Thus, when seal-out is a cause of the generation thereof, an amount of the generated hydrogen sulfide gas is relatively small.

On the other hand, for example, when an internal short circuit occurs in electrode assembly 46, the temperature of electrode assembly 46 becomes high, with the result that hydrogen sulfide gas may be generated. An amount of the hydrogen sulfide generated by the internal short circuit is larger than the amount of the hydrogen sulfide generated by the seal-out.

When the hydrogen sulfide generated from battery modules 21, 22 reaches recess 68, gas detection sensors 70, 71 can detect the hydrogen sulfide. Since the specific gravity of the hydrogen sulfide gas is heavier than that of air, the hydrogen sulfide gas is accumulated on bottom surface 63 of case 20 in FIG. 4. In particular, since recess 68 is formed to extend downward from general surface 64, the generated hydrogen sulfide gas is likely to be accumulated in recess 68.

Since gas detection sensors 70, 71 are disposed in recess 68, gas detection sensors 70, 71 can detect the hydrogen sulfide gas excellently when the hydrogen sulfide gas is generated.

In FIG. 3, recess 68 is disposed between mounting surface 66 and mounting surface 67. Therefore, gas detection sensors 70, 71 can excellently detect both the hydrogen sulfide gas generated from battery module 21 shown in FIG. 2 and the hydrogen sulfide gas generated from battery module 22 shown in FIG. 2.

It should be noted that in FIG. 4, when the hydrogen sulfide gas is generated in case 20 to increase the internal pressure in case 20, the gas in case 20 is discharged to the outside of case 20 through breather membrane 36, duct 37, and breather membrane 35. When the gas in case 20 passes through duct 37, hydrogen sulfide in the gas is adsorbed by desulfurization agent 38. Thus, the hydrogen sulfide gas can be prevented from being discharged to the outside of case 20.

In power storage device 1 according to the present embodiment, abnormality processing control is performed based on signals output from gas detection sensors 70, 71 to controller 11.

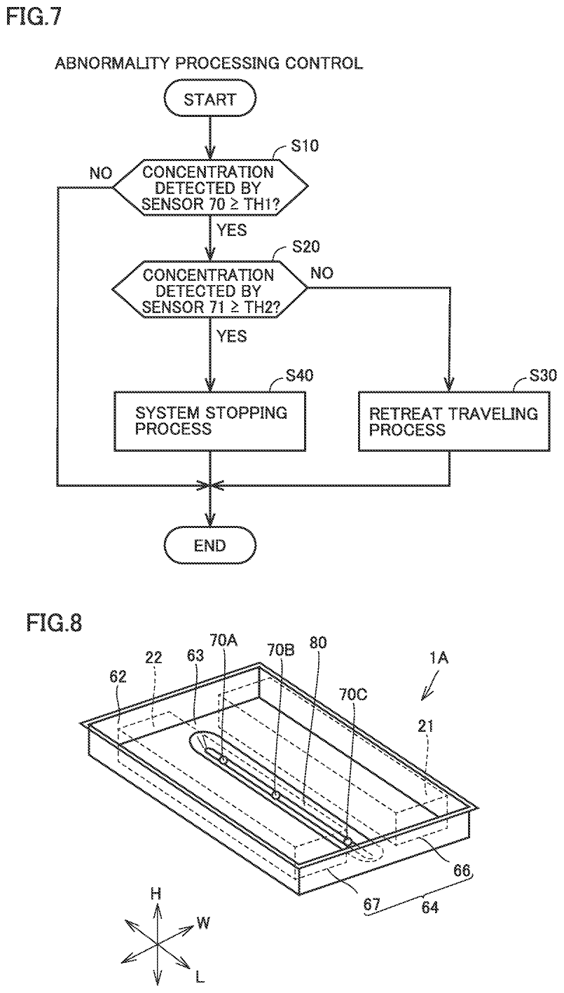

FIG. 7 is a flowchart showing exemplary abnormality processing control performed by controller 11. A control flow shown in FIG. 7 is continuously and repeatedly performed.

Controller 11 receives signals from gas detection sensors 70, 71. Controller 11 specifies a concentration of hydrogen sulfide detected by gas detection sensor 70 based on the signal from gas detection sensor 70, and determines whether or not the specified concentration is equal to or more than a threshold value TH1 (Step 10).

It should be noted that since hydrogen sulfide does not normally exist in case 20, threshold value TH1 may be a lower detection limit value for the hydrogen sulfide sensor.

When controller 11 determines that the concentration of the hydrogen sulfide detected by gas detection sensor 70 is equal to or more than threshold value TH1 (Yes in Step 10), controller 11 determines whether a concentration of hydrogen sulfide detected by gas detection sensor 71 is equal to or more than a threshold value TH2 (Step 20). It should be noted that threshold value TH2 is equal to or more than threshold value TH1.

When controller 11 determines that the concentration of the hydrogen sulfide detected by gas detection sensor 71 is less than threshold value TH2 (No in Step 20), controller 11 performs a retreat traveling process (Step 30).

In the retreat traveling process, the output of the rotating electrical machine of driving device 10 is restricted. Thus, an amount of charging/discharging of power storage device 1 can be reduced, thereby suppressing generation of hydrogen sulfide. Further, controller 11 displays, on HMI device 12, an indication “BATTERY ABNORMAL STATE” and an indication that it is necessary to “GO TO A REPAIR GARAGE”.

It should be noted that since vehicle 2 can travel even when the retreat traveling process is performed, the user can move vehicle 2 to a repair garage or the like.

When controller 11 determines that the concentration of the hydrogen sulfide detected by gas detection sensor 71 is equal to or more than threshold value TH2 (Yes in Step 20), controller 11 performs a system stopping process (Step 40).

In the system stopping process, an SMR is brought into an open state (disconnection state) so as to disconnect a power path from power storage device 1 to the PCU of driving device 10. Thus, in the case where vehicle 2 is traveling, vehicle 2 is stopped. Further, by the system stopping process, an indication “SYSTEM STOPPING PROCESS” and an indication to request to “MAKE A STOP AT A ROAD SHOULDER” are displayed on HMI device 12. It should be noted that vehicle 2 is preferably avoided from being stopped on the road by delaying the disconnection of the SMR by a short period of time to allow vehicle 2 that is traveling to be stopped at the road shoulder after HMI device 12 displays the indications “SYSTEM STOP PROCESS” and “MAKE A STOP AT A ROAD SHOULDER”.

Gas detection sensor 71 is located above gas detection sensor 70. When the concentration of the hydrogen sulfide detected by gas detection sensor 71 is less than threshold value TH2, it can be presumed that the amount of the generated hydrogen sulfide is small. Therefore, controller 11 performs the retreat traveling process.

On the other hand, when the concentration of the hydrogen sulfide detected by gas detection sensor 71 is equal to or more than threshold value TH2, the system stopping process is performed. This is due to the following reason: since at least part of the gas in driving device 10 is discharged from desulfurization unit 23 to the outside but the hydrogen sulfide has reached the upper portion of recess 68, it can be presumed that a large amount of hydrogen sulfide is generated.

In the present embodiment, it has been illustratively described that the plurality of gas detection sensors 70, 71 are provided in recess 68; however, one gas detection sensor may be provided therein. It should be noted that even when one gas detection sensor is provided in recess 68, hydrogen sulfide can be excellently detected.

In the present embodiment, it has been illustratively described that each gas detection sensor is employed as the “gas collection unit”; however, a gas adsorbing agent, a gas removing agent, a desulfurization agent, or the like may be disposed in recess 68 as the “gas collection unit”.

Since the hydrogen sulfide has a density higher than that of air, the generated hydrogen sulfide is likely to enter recess 68. Therefore, by disposing the desulfurization agent in recess 68, desulfurization can be efficiently performed.

### (Modification 1)

A power storage device 1A according to a modification 1 will be described with reference to FIG. 8 and the like. FIG. 8 is a perspective view schematically showing power storage device 1A with an upper case 31 being removed. A groove portion 80 is formed in a bottom surface 63 of power storage device 1A, and configurations other than groove portion 80 are the same as those of power storage device 1 described above.

Groove portion 80 is formed to extend in the horizontal direction. In the example shown in FIG. 8, groove portion 80 is formed to extend in forward/backward direction L of vehicle 2. In forward/backward direction L, groove portion 80 extends from one end to the other end of each of battery modules 21, 22.

A plurality of gas detection sensors 70A, 70B, 70C are disposed at intervals in groove portion 80. Therefore, even when hydrogen sulfide is leaked out from a battery cell 25 of battery modules 21, 22, the hydrogen sulfide can be excellently detected. It should be noted that in modification 1, groove portion 80 corresponds to the “protruding portion”.

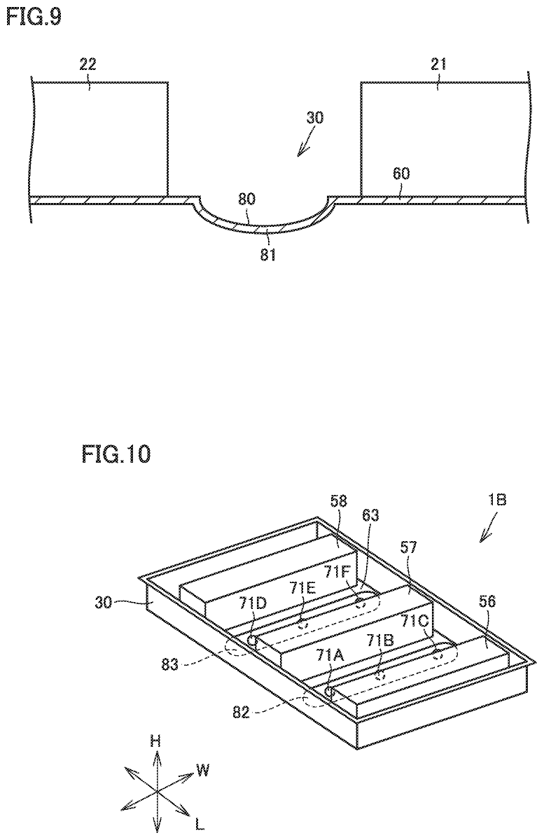

FIG. 9 is a cross sectional view showing configurations of and around groove portion 80. Groove portion 80 is formed by deforming a portion of bottom plate 60 of lower case 30 so as to protrude downward. Therefore, a bead 81 protruding downward is formed in bottom plate 60.

Since groove portion 80 and bead 81 are each formed to extend in forward/backward direction L, rigidity of bottom plate 60 in forward/backward direction L can be high.

### (Modification 2)

A power storage device 1B according to a modification 2 will be described with reference to FIG. 10 and the like. FIG. 10 is a perspective view schematically showing power storage device 1B with an upper case 31 being removed. Power storage device 1B includes a plurality of battery modules 56, 57, 58 disposed at intervals in forward/backward direction L. Each of battery modules 56, 57, 58 is formed to extend in width direction W.

A plurality of groove portions 82, 83 each extending in width direction W are formed in bottom surface 63 of power storage device 1B. Groove portion 82 is formed between battery module 56 and battery module 57, and groove portion 83 is formed between battery module 57 and battery module 58.

Power storage device 1B includes: a plurality of gas detection sensors 71A, 71B, 71C provided in groove portion 82; and a plurality of gas detection sensors 71D, 71E, 71F provided in groove portion 83. It should be noted that groove portion 82 and groove portion 83 each correspond to the “protruding portion” of the present disclosure.

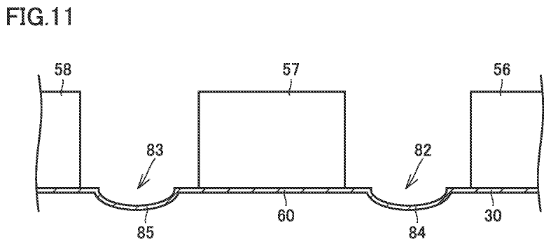

FIG. 11 is a cross sectional view showing configurations of and around groove portion 82 and groove portion 83. Each of groove portion 82 and groove portion 83 is formed by deforming a portion of bottom plate 60 of lower case 30 so as to protrude downward. Therefore, a bead 84 and a bead 85 each protrude downward are formed in bottom plate 60.

Since groove portions 82, 83 and beads 84, 85 are each formed to extend in width direction W, rigidity of bottom plate 60 in width direction W can be high.

Although the embodiments of the present disclosure have been described and illustrated in detail, it is clearly understood that the same is by way of illustration and example only and is not to be taken by way of limitation. The scope of the present disclosure is defined by the terms of the claims, and is intended to include any modifications within the scope and meaning equivalent to the terms of the claims.

What is claimed is:

1. A power storage device comprising:
a battery cell having a sulfide solid electrolyte;
a case that accommodates the battery cell; and
at least one gas collection unit that is disposed in the case and that detects hydrogen sulfide, wherein
a protruding portion is formed in an inner surface of the case, the protruding portion protruding from the inner surface of the case toward outside of the case, and
the gas collection unit is disposed in the protruding portion.

2. The power storage device according to claim 1, wherein the gas collection unit is a gas detection sensor.

3. The power storage device according to claim 1, wherein
a plurality of the gas collection units are provided, and
when a direction in which the protruding portion protrudes from the inner surface of the case toward the outside of the case is defined as a protruding direction, the plurality of the gas collection units are disposed in the protruding portion at different positions in the protruding direction.

4. The power storage device according to claim 1, wherein
the inner surface of the case includes a mounting surface on which the battery cell is disposed, and
the protruding portion is formed to protrude toward the outside of the case with respect to the mounting surface.

5. The power storage device according to claim 1, wherein
the case includes a bottom plate, and
the protruding portion is a groove portion formed by deforming the bottom plate so as to protrude toward the outside of the case.

6. A vehicle comprising the power storage device according to claim 1, wherein
the power storage device is mounted on the vehicle such that the protruding portion protrudes downward.

7. The vehicle according to claim 6, wherein
the case includes a bottom plate,
the protruding portion is a groove portion formed by deforming the bottom plate so as to protrude downward, and
the groove portion is formed to extend in a forward/backward direction of the vehicle.

8. The vehicle according to claim 6, wherein
the case includes a bottom plate,
the protruding portion is a groove portion formed by deforming the bottom plate so as to protrude downward, and
the groove portion is formed to extend in a width direction of the vehicle.
